(19) United States
(12) Patent Application Publication
(10) Pub. No.: US 2010/0154423 A1
(43) Pub. Date: Jun. 24, 2010

(54) SYSTEM FOR MIXING GAS FLOWS IN A GAS TURBINE ENGINE, GAS TURBINE ENGINE AND AN AIRCRAFT ENGINE

(75) Inventors: Martin Olausson, Goteborg (SE); Bernhard Gustafsson, Goteborg (SE)

Correspondence Address: WRB-IP LLP, 1217 KING STREET, ALEXANDRIA, VA, 22314, US

(73) Assignee: VOLVO AERO CORPORATION, TROLLHATTAN (SE)

(21) Appl. No.: 12/600,261

(22) PCT Filed: Jun. 4, 2007
(86) PCT No.: PCT/SE07/00539

§ 371 Date: Nov. 15, 2009

(30) Foreign Application Priority Data
May 22, 2007 (SE) 0701240-4

(51) Int. Cl. F02C 7/045

(52) U.S. Cl. 60/725

(57) ABSTRACT

A system is provided for mixing gas flows in a gas turbine engine. The system includes an annular wall structure which internally delimits a channel for a first gas flow. The wall structure includes a plurality of first wall portions. At least one of the first wall portions is movably arranged in a radial direction between a first position and a second position for mixing an external gas flow with the first gas flow.

### BACKGROUND AND SUMMARY

The invention relates to a system for mixing gas flows in a gas turbine engine, 5 wherein the system comprises an annular wall structure, which internally delimits a channel for a first gas flow. The invention further relates to a gas turbine engine comprising the mixing system and an aircraft engine comprising the gas turbine engine. The invention is particularly directed at a system for reducing noise from an aircraft engine.

Noise generated by aircraft jet engines during takeoff and landing is a matter of serious concern in most metropolitan areas of the world. In many areas where people live or work adjacent to airports they may be significantly 5 affected by aircraft noise. Many municipalities have taken action to require reduction in aircraft noise. Much work has been done on designing turbofan aircraft engines to reduce noise levels.

Generally, in turbofan jet aircraft engines, the engine airflow is split into two parts as it passes through the engine, i.e. the primary or core flow and the 0 fan or bypass flow. The primary or core flow passes through the low pressure and high pressure compressors and into the combustion chamber where fuel is mixed with the high pressure air and burned. The core flow then passes through the high and low pressure turbines and into the exhaust duct. The fan or bypass air flow only passes through the fan and is routed around the 5 core engine and into the exhaust duct. In low bypass ratio confluent turbofan nacelles, the two flows enter into the exhaust duct at approximately equal pressure but at very different temperatures. Examples of temperature may be approximately 110° C. for the bypass flow and approximately 600° C. for the core flow. The two flows will mix as they exhaust through the exhaust end, or tailpipe of the jet engine. The exhaust jet exits the engine at a more uniform and higher velocity, which, generates a large part of the engine jet noise.

One apparatus which has been developed and which has achieved beneficial results in the noise reduction of turbofan aircraft engines is the flow mixer of the multi-channel or multi-lobe inverted flow type. Examples of use of such mixers for noise suppression are found in the U.S. Pat. Nos. 4,117,671 and 4,077,206. These flow mixers mix the two gas flows to cause the gas flowing through the tailpipe to flow at the same velocity. These flow mixers have been credited with noise reduction in the range of 3.5 to 4.5 decibels (db) in the Effective Perceived Noise Level (EPNL), depending upon the engine cycle and bypass ratio. While this noise reduction is helpful, it is not sufficient in itself to solve all of the low bypass turbofan engine noise problems, and for this reason the exhaust flow mixer has had a limited commercial application.

To obtain larger magnitudes of noise reduction in jet engines, a traditional approach has been to mix ambient air flow with the jet engine gas flow to reduce jet velocity and associated noise. An example of such a solution is shown in U.S. Pat. No. 3,710,890. In order to provide a relatively large noise reduction, large ejector inlets with high secondary air flows have been used, which have resulted in unacceptable levels of net thrust loss at cruise speeds.

It is desirable to achieve a gas mixing system for a gas turbine engine, which creates conditions for a reduced noise during at least part of the operating range of the engine and minimal impact on engine performance.

According to an aspect of the present invention, a system is provided for mixing gas flows in a gas turbine engine, wherein the system comprises an annular wall structure, which internally delimits a channel for a first gas flow, characterized in that the wall structure comprises a plurality of first wall portions, that at least one of the first wall portions is movably arranged in a radial direction between a first position and a second position for mixing an external gas flow with the first gas flow.

In this context, the term “annular” should be interpreted to include an annular element having a continuous or a partial extent in a circumferential direction. For instance, an annular element may comprise a circular ring or a segment thereof. Further; the term “annular” is not restricted to a circular shape, but may comprise any other shapes, such as ellipsoidal and rectangular shapes.

The mixing system is preferably applied in a turbofan engine, for instance a low bypass turbofan engine, which may have both fan and core exhaust air flow streams arranged concentrically at its exhaust end and exiting the engine along the longitudinal axis thereof.

In the subsequent text, terms such as “upstream”, “downstream”, “forward”, “rear” refers to the location of individual parts or components in relation to the direction of gas flow through the engine from the front to the rear thereof.

More particularly, the noise during take-off may be reduced by reducing the speed and temperature of the exhaust jet. This may be achieved by means of the inventive mixing system in that ambient air flow is introduced during takeoff, wherein a further effect is that the mass flow is increased. A high by-pass ratio is advantageous during take-off. However, during cruise conditions, a larger part of the air flow through the engine should pass the combustion chamber, wherein a lower by-pass ratio is achieved. The inventive mixing system creates conditions for achieving both the high by-pass ratio during take-off and the low by-pass ratio during cruising conditions.

More specifically, the inventive mixing system creates conditions for mixing ambient air in the outlet jet from the engine in an efficient way while also providing for varying the area of the inner gas flow and/or an outer gas flow.

The movable first wall portions form adjustable flow controlling means, in the form of movable control surfaces, ramps, or similar. Each such movable first wall portion may comprise a sheet of metal, metal alloy or composite material, or a similar material suitable for use in the exhaust nozzle of a turbofan engine.

According to a preferred embodiment, the first wall portions form a circumferentially continuous nozzle when the movable first wall portion is in the second position. With regard to an aircraft engine, the second position is preferably applied during cruise conditions. Preferably, the end of this first nozzle forms the narrowest part of the exhaust nozzle. Preferably, the wall structure is configured to obstruct mixing of the first gas flow with the external second gas flow (ambient air) when the first movable wall portions are in the second radial position.

According to a further preferred embodiment, there is a gap between two adjacent movable first wall portions in a circumferential direction of the annular wall structure when they are arranged in the first position. Preferably, the wall structure is configured to allow mixing of the first gas flow with the external second gas flow (ambient air) when the first movable wall portions are in the first radial position. More particularly, the ambient air may be introduced between two adjacent movable first wall portions. With regard to an aircraft engine, the first position is preferably applied during take-off conditions.

According to a further preferred embodiment, an edge of the movable first wall portion, which forms an end in an axial direction of the annular wall structure, defines a first inner radius in the first position, and a second inner radius in the second position, wherein the first inner radius is larger than the second inner radius. The movable first wall portion is preferably pivotable between the first position and the second position. Preferably, a forward edge of the movable first wall portion is attached to the other part of the wall structure via a pivot joint, wherein a rear edge of the movable first wall portion forms the free end. Preferably, each of the movable first wall portions is pivotable about an axis extending at right angles relative to an axial direction of the annular wall structure.

The first wall portions may have a planar or curved cross-section in a radial plane through the wall structure. The width and/or curvature of each first wall portion in a radial plane through the engine is determined by the number of wall portions and/or the diameter of the convergent nozzle in said plane when the movable first wall portions are pivoted into their second position. According to one example, the wall structure is attached to a rear end of an upstream first exhaust shroud. The length, width and thickness of the first wall portions are dependent on factors such as the length and diameter of the rear section of the upstream first exhaust shroud, the number of first wall portions, the angle of the first wall portions in their second position, the maximum aerodynamic force acting on the first wall portions etc. The width of each first wall portion may be constant or tapering towards the end of it in the axial direction. Displacement of the movable first wall portions may be achieved by arranging their front ends so that each wall portion is pivotable about a tangential axis. In this way the ramps can be displaced in a plane through the central axis of the turbofan engine and be placed either in a pivoted second position, forming a conical nozzle, or in a level first position, substantially coaxial with and forming an extension of the upstream first exhaust shroud.

According to a further preferred embodiment, the wall structure comprises a plurality of second wall portions, that each first movable wall portion is radially movably arranged between two adjacent second wall portions. The adjacent second wall portions have opposite parallel guide surfaces and opposite lateral edges of the first wall portion are positioned in contact with, or in the close vicinity of, the guide surfaces of the second wall portions in both said first and second position. Thus, a guide surface of each of the second wall portions, which surface faces the movable first wall portion, has a main extension substantially in a radial direction of the annular wall structure. These guide surfaces are preferably fixed with regard to the movable first wall portions and may be attached to the rear end of the upstream first exhaust shroud. In other words, the guide surfaces are arranged in parallel to the direction of movement of the first movable wall portions.

Each pair of guide surfaces associated with a movable first wall portion is connected by a rigid first wall portion, wherein these rigid first wall portions cooperate with the movable first wall portion to form the exhaust nozzle. As for the first wall portions, the width and/or curvature of each of them in a radial plane through the engine is determined by the number of first wall portions and the minimum and maximum diameter of the convergent nozzle when the movable first wall portions are pivoted into their second radial position.

According to a further preferred embodiment, the wall structure is movably arranged between an advanced axial position and a retracted axial position, wherein the advanced axial position corresponds to that the movable first wall portions are arranged in the first radial position and the retracted axial position corresponds to that the movable first wall portions are arranged in the second radial position. Preferably, the system comprises a link arrangement adapted to displace the movable first wall portions between the first and second radial positions as the wall structure is advanced and retracted, respectively between the axial positions.

According to one example, the advanced and retracted positions of the wall structure may be achieved by an axial displacement of the first upstream exhaust shroud. The first exhaust shroud may be movably connected to and displaceable relative to an external turbine shroud. This displacement may be achieved by allowing the forward end of the first exhaust shroud to be displaced inside an inner surface or outside an outer surface of a rear section of the turbine shroud. Alternatively, the forward end of the first exhaust shroud may be displaced into a space between an inner and an outer surface of a rear section of the turbine shroud. According to one example, the displaceable first exhaust shroud is a fan air shroud.

In this example, each of the adjustable first wall portions may be arranged to be adjusted by an individual or a common mechanical linkage mounted between the movable first wall portions and a stationary second exhaust shroud. The linkages may be attached to a rear section of each of the movable first wall portions, which are mounted to the rear section of the first exhaust shroud. The mechanical linkages are preferably, but not necessarily, mounted between the movable first wall portions on the first exhaust shroud and a front section of the second exhaust shroud. The mechanical linkages may comprise individual linkages connecting each first flow controlling means the second exhaust shroud. Alternatively, the mechanical linkages connecting each movable first wall portions and the second exhaust shroud are interconnected to ensure simultaneous actuation of the movable first wall portions. In this way the mechanical linkages are actuated by the relative displacement between the first and second exhaust shrouds.

According to a second example, each movable first wall portions is arranged to be adjusted by an individual or a common mechanical linkage mounted between the movable first wall portions and the turbine shroud. The linkages may be attached between the rear sections of each of the movable first wall portions, via the first exhaust shroud, to a rear section of the turbine shroud. In this way the mechanical linkages are actuated by the relative displacement between the first exhaust shroud and the turbine shroud.

According to a second alternative embodiment, each movable first wall portion described above is arranged to be adjusted by individual or one or more common actuators. As described above, a mechanical linkage may be attached to the rear section of each of the movable first wall portions, which are mounted to the rear section of the first exhaust shroud. The actuator or actuators may comprise electrically, hydraulically or mechanically operated actuators.

According to a first example, the mechanical linkages may be attached to individual actuators or one or more common actuators, which are mounted to the rear section of the first exhaust shroud forward of the first flow controlling means. According to a second example, the mechanical linkages may be attached to individual actuators or one or more common actuators, which are mounted to the front section of the second exhaust shroud. According to a third example, the mechanical linkages may be attached to individual actuators or one or more common actuators, which are mounted to the rear section of the turbine shroud.

In the first alternative embodiment, the actuation of the movable first wall portions and the first exhaust shroud are simultaneous. The second alternative embodiment allows for separate control of the movable first wall portions and the first exhaust shroud.

According to a further preferred embodiment, the system comprises a central cone, and that the wall structure is positioned co-axially with the cone and is axially displacable relative to the cone. Preferably, the cone has a tapering radial extension from a portion with a maximum radial extension towards an end in the axial direction. Preferably, a rear end of the wall structure is arranged in the vicinity of the maximum radial extension of the cone in the axially advanced position.

### BRIEF DESCRIPTION OF DRAWINGS

The invention will be described in detail with reference to the attached figures. It is to be understood that the drawings are designed solely for the purpose of illustration and are not intended as a definition of the limits of the invention, for which reference should be made to the appended claims. It should be further understood that the drawings are not necessarily drawn to scale and that, unless otherwise indicated, they are merely intended to schematically illustrate the structures and procedures described herein.

FIG. 1 shows a cross-section of a turbofan engine according to the invention during cruise;

FIG. 2A is a partly cut view of a rear end of the turbofan engine 1 of FIG. 1;

FIG. 2B is an alternative configuration to FIG. 2A;

FIG. 3 shows a rear view of the exhaust nozzle in FIG. 2A;

FIG. 4 shows a perspective view of a sector of the ramps in FIG. 3;

FIG. 5 shows a cross-section of the rear end of the turbofan engine of FIG. 1 during take-off; and

FIG. 6 shows a rear view of the exhaust nozzle in FIG. 5;

FIG. 7 shows a perspective view of a sector of the ramps in FIG. 6;

### DETAILED DESCRIPTION

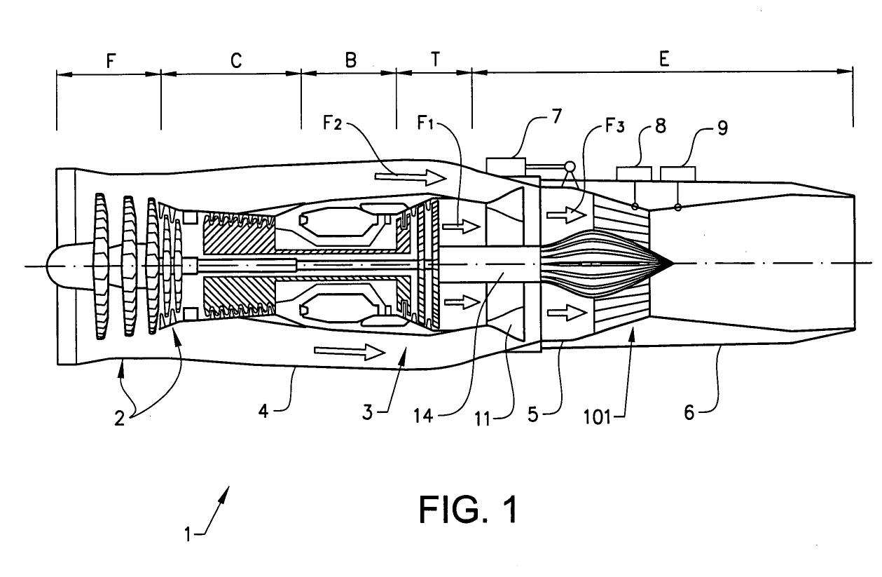

FIG. 1 shows a schematic cross-section of a gas turbine engine 1 in the form of an aircraft engine according to the invention. More particularly, the aircraft engine constitutes a turbofan engine. The turbofan engine 1 comprises a fan section F, compressor section C, combustor section B, turbine section T and exhaust section E. The compressor section C is enclosed by a compressor shroud 2, while the turbine section T is enclosed by a turbine shroud 3. An incoming gas flow is divided into a central core flow F1 and a fan flow F2 after the fan section F. The central core flow F1 enters the compressor section C while the fan flow F2 bypasses the compressor section C, combustor section B and turbine section T by flowing between an external fan flow shroud 4 and the compressor shroud 2 and the turbine shroud 3. The core flow F1 and fan flow F2 are mixed downstream the turbine section T to an outlet flow F3. A first flow mixer 11 is attached downstream of the turbine section T of the engine and configured for mixing the core flow F1 and fan flow F2. The exhaust section E is enclosed by a first and second exhaust shroud 5, 6.

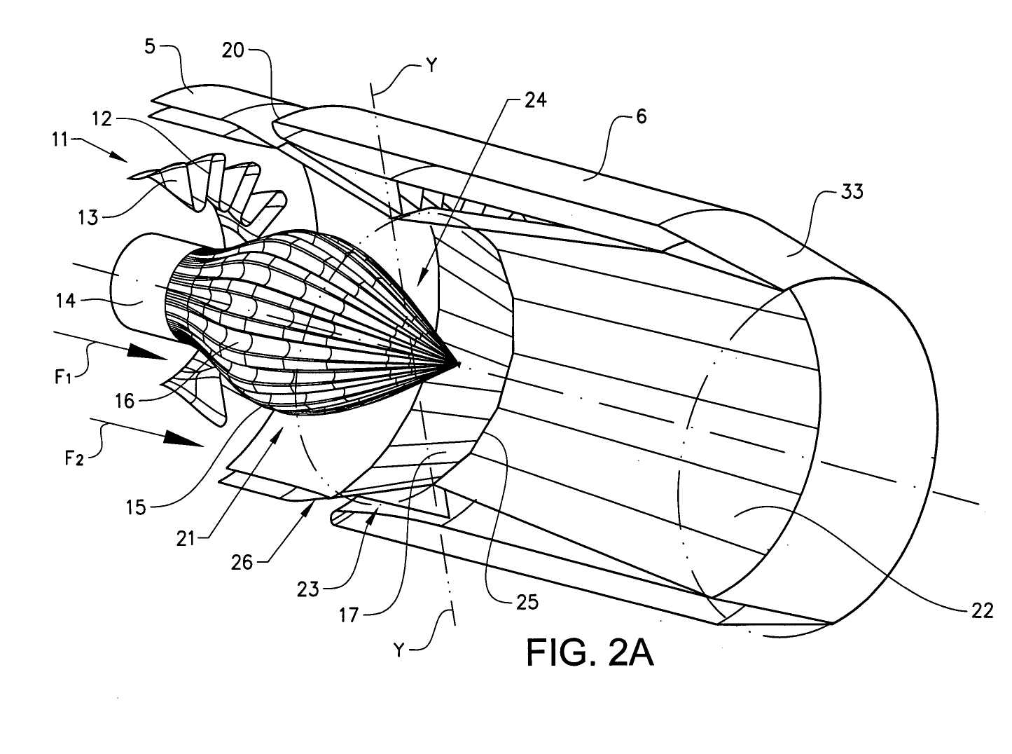

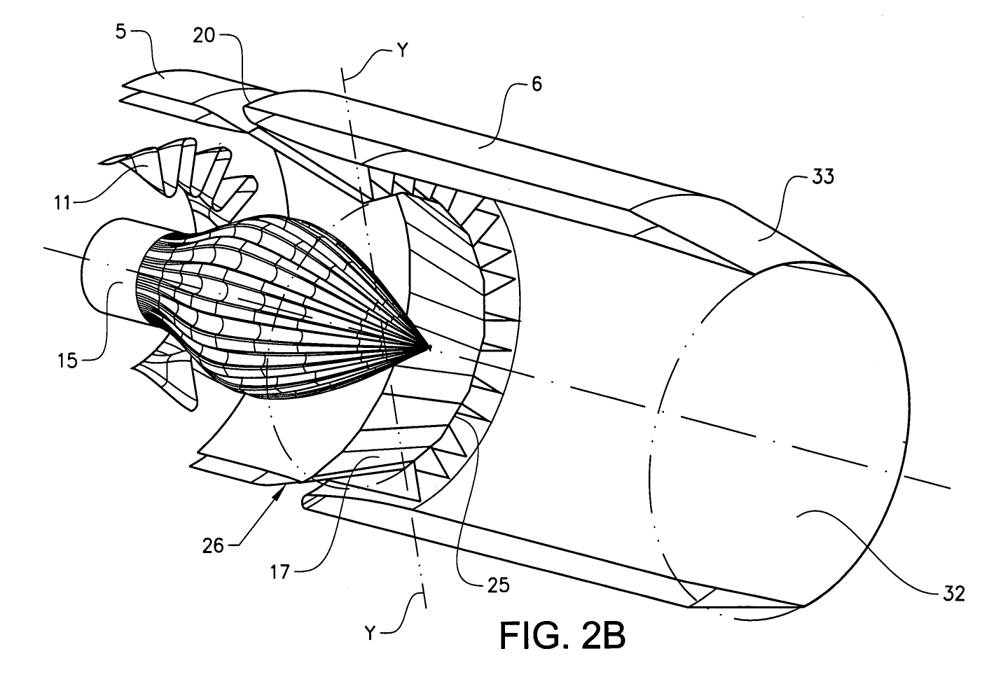

FIG. 2A is a partly cut view of a rear end of the turbofan engine 1 of FIG. 1. The first flow mixer 11 has a rear end 12 having a plurality of fixed wave-like lobes 13 and is attached around a central core 14 upstream of a bulb shaped thrust cone 15 located in an exhaust end of said turbofan engine 1.

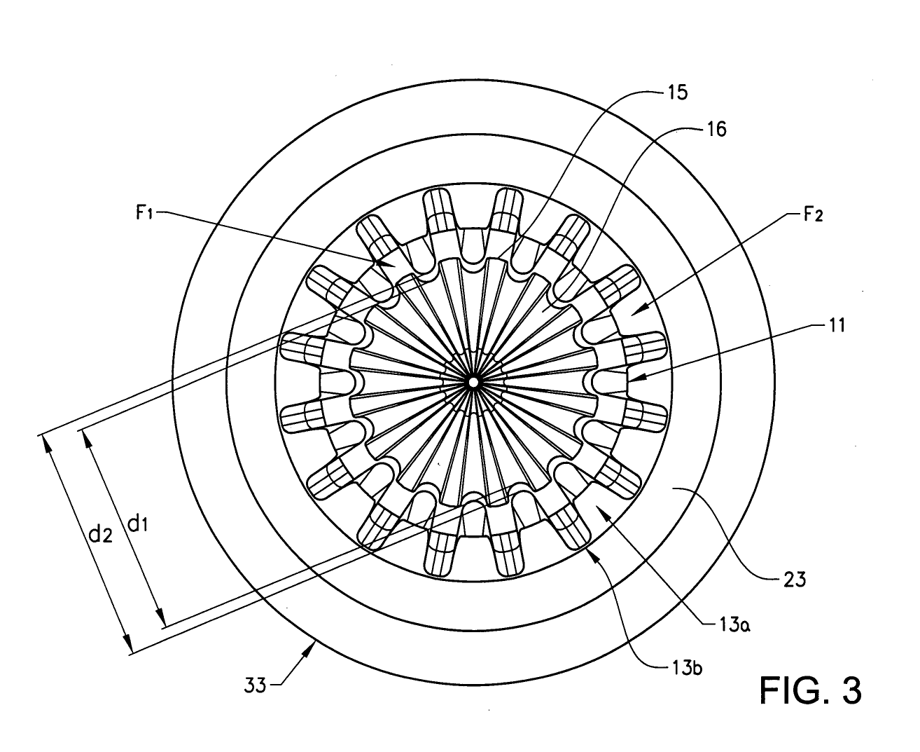

The first flow mixer 11 is mounted in a fixed position relative to the thrust cone 15. The bulb-shaped thrust cone 15 is provided with a plurality of longitudinal grooves 16 in its outer surface. FIG. 3 shows a rear view of the exhaust nozzle in FIG. 2A. In the embodiment shown, inner and outer lobes 13a, 13b are provided. Preferably, each groove 16 is indexed to coincide with each inner lobe section 13a of the first flow mixer 11. Thus, the effect of the inner lobe sections 13a, ie the effect of the depth of the lobes, is increased. Further, axial vortex structures are created, which will mix the flow in the center of the outlet. At a section X through the major, or maximum, diameter of the thrust cone 15, a circle with a diameter di coinciding with the bottom of each groove is equal to a diameter d2 coinciding with the innermost portions of the inner lobe sections 13a of the first flow mixer 11. Alternatively, the diameter di may be equal to or even larger than the diameter d2. Said first flow mixer 11 is contained within the first exhaust shroud 5 located between the turbine shroud 4 and the second exhaust shroud 6.

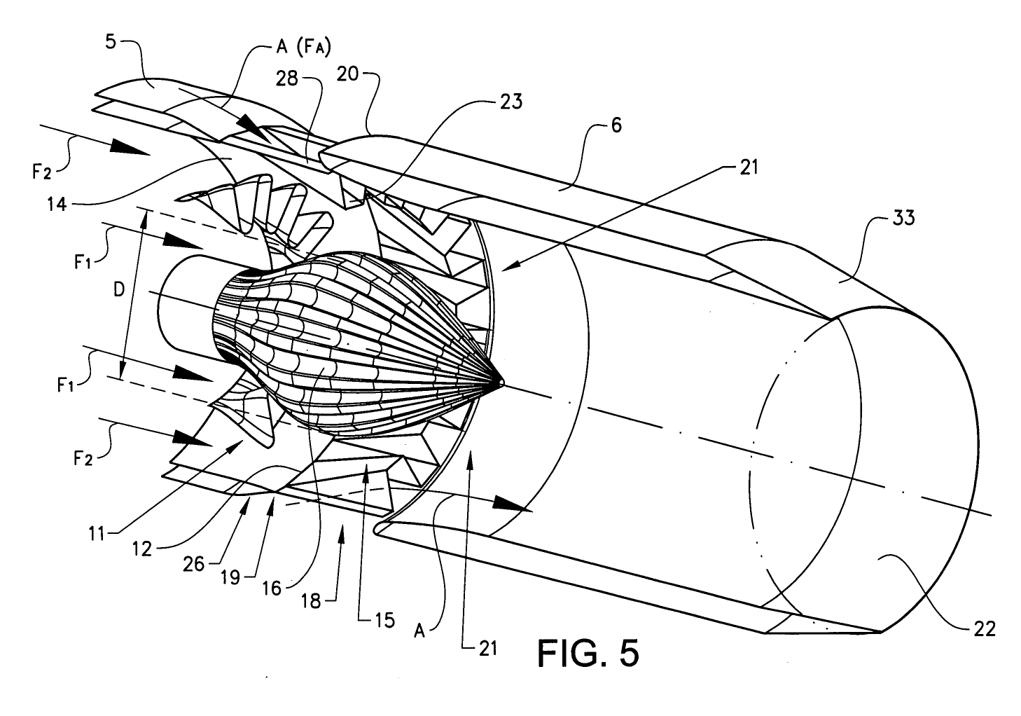

A system 101 for mixing gas flows is arranged downstream of the first flow mixer 11, see FIG. 1. The mixing system 101 comprises an annular wall structure 23, which internally delimits a first gas flow channel, see FIG. 2A. The mixing system 101 is configured for mixing the outlet flow F3 from the first flow mixer 11 with a further gas flow in the form of ambient air. The wall structure 23 is movably arranged in an axial direction between a retracted position and an advanced position. The wall structure 23 is configured for allowing introduction of the ambient air FA in the outlet gas flow F3 in the advanced position, see FIG. 5. The arrow A indicates a flow FA of ambient air introduced in the outlet gas flow F3 via an ejector effect. The advanced position is advantageously used during take-off. Further, the wall structure 23 is configured for blocking any introduction of ambient air in the outlet gas flow F3 in the retracted position, see FIG. 2A. The retracted position is advantageously used during cruising conditions.

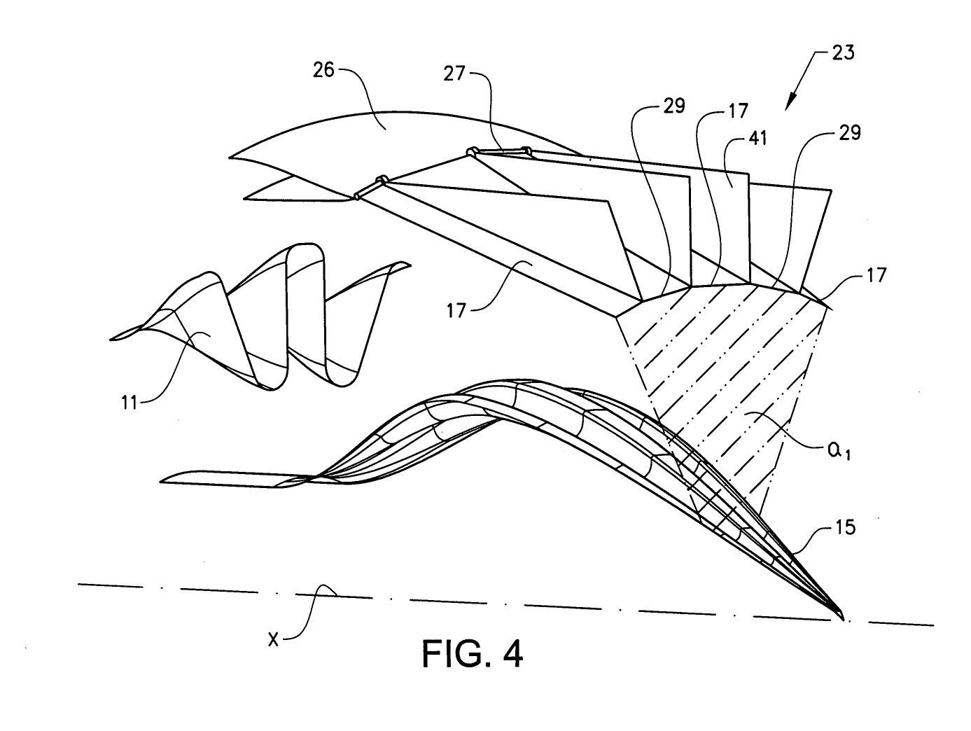

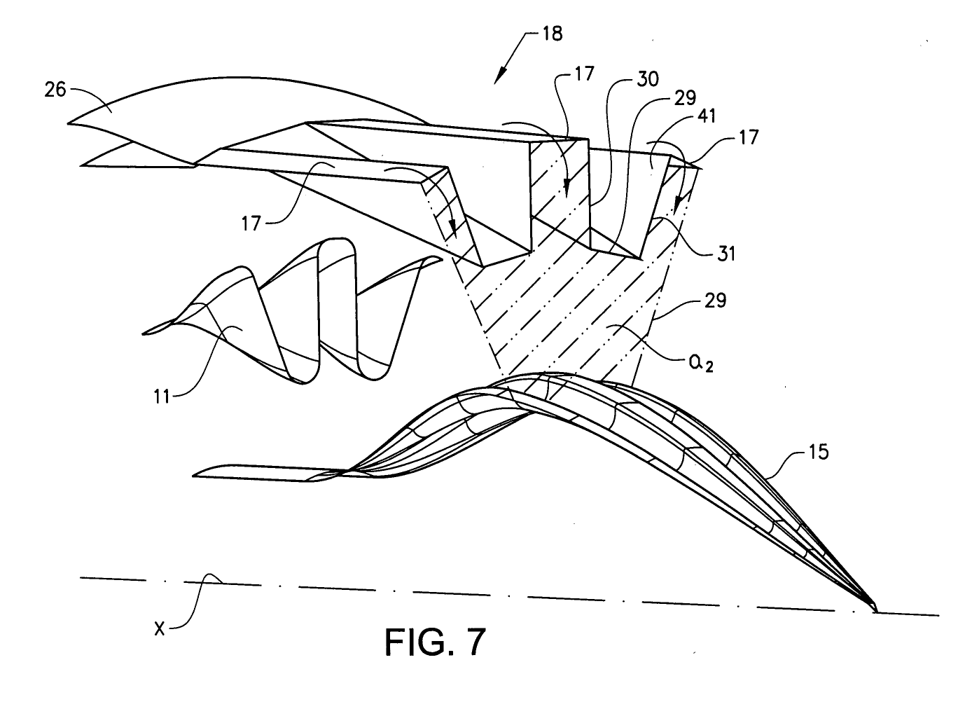

Reference will in the following be made to FIGS. 4 and 7. The wall structure comprises a plurality of first wall portions 17,29. Every second first wall portion 17 in the circumferential direction is movably arranged in a radial direction of the annular wall structure. The radial movement is illustrated with arrows in FIG. 7. Further, every second first wall portion 29 in the circumferential direction is fixed in relation to the movable wall portions 17. The movably arranged wall portions 17 are adjustable between a first position (see FIG. 7), in which an edge, which forms an end in an axial direction of the annular wall structure, defines a first inner radius, and a second position (see FIG. 4), in which the wall portion edge defines a second inner radius.

The edges of the first wall portions 17,29 form a circumferentially substantially continuous and convergent nozzle when the movable first wall portions 17 are in the second position, see FIG. 4. The nozzle is coaxial with the bulb shaped thrust cone 15. On the other hand, the edges of adjacent movable first wall portions 17 are circumferentially spaced in the first position, see FIG. 7.

The movable first wall portions 17 are pivotable between the first position and the second position. More particularly, each of the movable first wall portions 17 is pivotable about an axis 27 extending at right angles relative to an axial direction X of the annular wall structure.

Further, the first wall portion edge extends in a plane at right angles relative to the axial direction X of the annular wall structure. Thus, the free edge is in parallel with the pivot axis. Further, each first wall portion 17 is defined by two parallel lateral edges, wherein the movable wall portion 17 has a rectangular shape.

The wall structure comprises a plurality of upright, second wall portions 41, wherein each first movable wall portion 17 is radially movably arranged between two adjacent second wall portions 41. The adjacent second wall portions 41 have opposite parallel guide surfaces 30 and opposite lateral edges of the first movable wall portion 17 is positioned in contact with, or in the close vicinity of, the guide surfaces of the second wall portions in both said first and second position.

The movably arranged first wall portions 17 form adjustable flow control means, or first ramps. In operation, the first ramps 17 form a combined flow mixer and ejector when the wall structure is in the advanced axial position (see FIG. 5), and it will be referred to as a “flow mixer” in the subsequent text.

The second exhaust shroud 6 is provided in the form of a cylindrical ejector shroud. At least a front section 20 of the second exhaust shroud 6 is supported concentrically around a central section 21 of the bulb shaped thrust cone 15. The second exhaust shroud 6 shown in FIG. 2A is provided with second flow controlling means or ramps 22 arranged to be adjustable between a first position, forming a second nozzle continuous with the nozzle formed by the wall structure 23 in the retracted position, and a second position, forming a part of or located adjacent a substantially cylindrical, inner surface of the second exhaust shroud 6 (see FIG. 5). The nozzle formed by the second ramps 22 is arranged to form a divergent nozzle for a supersonic flight. In their first position, the forward sections of the second ramps 22 are arranged in contact with or adjacent the rear sections of the first ramps 17 located in their respective second radial position. The inner diameter of the forward section of the second nozzle is equal to the corresponding diameter of the rear section of the first nozzle. In this way the exhaust stream may pass the joint between the convergent first nozzle and the divergent second nozzle with a minimum of turbulence or flow resistance added to the exhaust stream. The total length of the second exhaust nozzle is selected between 2-3 times the inner diameter of the second exhaust shroud 6. The second ramps 22 are provided with an acoustic liner in their internal surfaces.

FIG. 2B shows an embodiment provided with a first nozzle formed by the annular wall structure 23 only, wherein the second exhaust shroud comprises a substantially cylindrical internal surface 32. An internal acoustic liner is provided on the inner surface of the second exhaust shroud 6.

Thus, in their second position, the first ramps 17 are arranged to form part of a convergent nozzle 23 that is coaxial with and surrounding a rear convergent section 24 of the bulb shaped thrust cone 15, see FIG. 2A. The adjustable first ramps 17, in the form of movable control surfaces, are arranged to assume the second position shown in FIG. 2A during cruise conditions. The end section 25 of this first nozzle 23 forms the narrowest flow area of the exhaust nozzle 23. In a section Y through this position (see reference numeral 25), the cross-sectional area of the nozzle, minus the area taken up by the thrust cone 15, is less than the available area for the fan flow Fl and the core flow F2 in a section taken through the first flow mixer 11.

FIG. 4 shows a perspective view of a sector of the ramps in FIG. 3. The adjustable first ramps 17 are shown in their second position, where they are located in line with the fixed first wall portions 29 to form the exhaust nozzle 23. In this figure the nozzle is shown without a number of parallel guide surfaces arranged on either side of the ramps 17 to guide their movement.

The guide surfaces will be described in further detail below. The hatched area â indicates a sector of the narrowest flow area of the exhaust nozzle 23 and of the first exhaust shroud 5 with the adjustable first ramps 17 are shown in their second position.

In their first position, shown in FIG. 5, the first ramps 17 are arranged to form a second flow mixer 18 with its rear end 25 coaxial with and surrounding a maximum diameter section D of the bulb shaped thrust cone 15 in said first position. The rear ends the first ramps 17 are arranged in, or alternatively, immediately behind a radial plane through the maximum diameter section D of the bulb shaped thrust cone 15. The adjustable first ramps 17 are arranged to assume the first position during take-off conditions.

The first ramps 17 are attached to a rear section 26 of the first exhaust shroud 5 and extend in a diametric plane thereof. The first ramps 17 have a curved cross-section in a radial plane through the engine. Displacement of the first ramps 17 is achieved by arranging their front ends 19 so that each first ramp is pivotable about a tangential axis 27 located adjacent the outer diameter of the rear section 26 the first exhaust shroud 5. In this way the rear ends of the first ramps 17 can be displaced in a plane through the central axis of the turbofan engine and be placed either in a pivoted second position, forming a part of a conical nozzle 23, or in a level first position, substantially coaxial with and forming extensions 28 of the first exhaust shroud 5.

The exit centre area of the second flow mixer 18 and the area of the second exhaust shroud are substantially open, with the thrust cone marking the end of the engine centre body extending a short distance to the rear of the rearmost part of the second flow mixer 18. By having no centre body in this section, there is savings in weight and size. The second exhaust shroud extends to the rear of the exit of the second flow mixer 18 for a distance equal to about 2-3 times the diameter of the inside of the shroud. The internal surface of the second exhaust shroud is lined with acoustically treated material tuned to absorb noise emanating from the mixer/nozzle combination. The ejector shroud 6 receives and entrains ambient or outside air. This ambient air enters between the rear end of the first exhaust shroud and the forward end of the second exhaust, or ejector shroud through an opening, or ejector inlets formed by the first ramps and the fixed control surfaces after forward displacement of the first exhaust shroud.

The above arrangement is designed for maximum aerodynamic efficiency at aircraft cruise speed while at the same time exhibiting improved low speed characteristics. Entrained ambient air flow is mixed with the engine air flow (both core and fan) inside the ejector shroud by the flow mixer 18. As a result, the mixed gas flow exits the ejector at greatly reduced velocity and associated noise level during take-off. Acceptable thrust levels are maintained by increase in total gas flow which compensates for the reduced exit velocity. A rearmost section of the second exhaust shroud 6 can be provided with means 33 for reversing thrust.

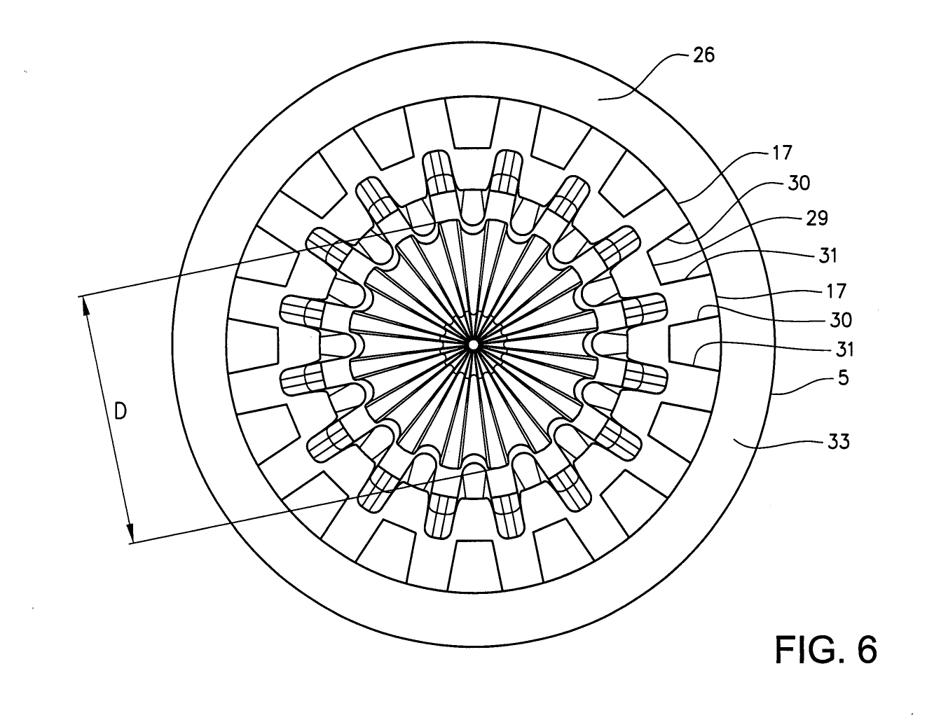

As shown in FIG. 6, each pair of adjustable first ramps 17 is separated by a fixed first wall portion 29 located between said adjustable first ramps 17. The fixed first wall portions 29 are attached to the rear end 26 of the first exhaust shroud 5.

Each of the adjustable ramps 17 is arranged to be movable in a radial plane between opposite, parallel guide surfaces 30, 31 of the second wall portions 41. The guide surfaces 30, 31 are arranged parallel to the direction of movement of the ramps 17 and form side surfaces in the second flow mixer 18 when the ramps 17 are located in their first positions. As shown in FIG. 3, each pair of guide surfaces 30, 31 associated with a first ramp 17 is rigidly interconnected by a fixed first wall portion 29. In other words, the rigid first wall portions 29 and the rigid second wall portions 41 together form a rigid element with regard to the movable first wall portions 17 (the rigid element in turn may be axially displaced relative to the stationary casing). The angled control surfaces 30, 31 cooperate with and guide the ramps 17 when they are displaced and angled inwards to form the first exhaust nozzle 23. In the same way as for the ramps 17, the width and curvature of each fixed first wall portion 29 in a radial plane through the engine is determined by the number of ramps 17 and the minimum and maximum diameter of the convergent nozzle 23 when the ramps 17 are pivoted into their second position. In the example shown, 16 ramps 17 and control surfaces are used.

FIG. 7 shows a perspective view of a sector of the ramps in FIG. 6. The adjustable first ramps 17 are shown in their first position, where they are located extending rearwards from the rear section 26 of the first exhaust shroud 5. In this position the adjustable first ramps 17 are substantially parallel with the longitudinal axis X of the engine. Each of the adjustable first ramps 17 is arranged to be movable in between the parallel guide surfaces 30, 31 connecting the fixed first wall portions 29. The guide surfaces 30, 31 are arranged parallel to the direction of movement of the first ramps 17 and form side surfaces in the second flow mixer 18 when the first ramps 17 are located in their first positions. The hatched area a2 indicates a sector of the narrowest flow area of the exhaust nozzle 23 and of the first exhaust shroud 5 with the adjustable first ramps 17 are shown in their second position.

The system 101 comprises a link arrangement adapted to displace the movable first wall portions 17 between the first and second radial positions as the wall structure is advanced and retracted, respectively between the axial positions. The linkages for displacement of the first ramps 17 during displacement of the first exhaust shroud 5 are schematically illustrated in FIG. 1. A first actuator 7 is arranged for axial displacement of the first exhaust shroud 5. A second actuator 8 is arranged for simultaneous displacement of the first ramps 17.

The invention is not limited to the examples described above, but may be varied freely within the scope of the appended claims. For instance, the center body (the cone) may be displaceable relative to an outer shroud in the axial direction.

Further, a plurality of wall structure designs is feasible. According to one example, the second wall portions (which are rigid with regard to the radial movement of the ramps) may be formed by v-shaped plates, wherein each single ramp is provided between and movable relative to two adjacent v-shaped plates.

1. A system for mixing gas flows in a gas turbine engine, wherein the system comprises an annular wall structure, which internally delimits a channel for a first gas flow, wherein the wall structure comprises a plurality of first wall portions, that at least one of the first wall portions is movably arranged in a radial direction between a first position and a second position for mixing an external gas flow with the first gas flow wherein the wall structure is movably arranged between an advanced axial position and a retracted axial position, that the advanced axial position corresponds to that the movable first wall portions are arranged in the first radial position and the retracted axial position corresponds to that the movable first wall portions are arranged in the second radial position.

2. A system according to claim 1, wherein the first wall portions form a circumferentially continuous nozzle when the movable first wall portion is in the second position.

3. A system according to claim 1, wherein there is a gap between two adjacent movable first wall portions in a circumferential direction of the annular wall structure when they are arranged in the first position.

4. A system according to claim 1, wherein, an edge of the movable first wall portion, which forms an end in an axial direction of the annular wall structure, defines a first inner radius in the first position, and a second inner radius in the second position, wherein the first inner radius is larger than the second inner radius.

5. A system according to claim 1, wherein the movable first wall portion is pivotable between the first position and the second position.

6. A system according to 5, wherein each of the movable first wall portions is pivotable about an axis extending at right angles relative to an axial direction of the annular wall structure.

7. A system according to claims 1, wherein an edge of the movable first wall portion, which forms an end in an axial direction of the annular wall structure, defines a first inner radius in the first position, and a second inner radius in the second position, the first inner radius is larger than the second inner radius, each of the movable first wall portions is pivotable about an axis extending at right angles relative to an axial direction of the annular wall structure, and the first wall portion edge extends in a plane at right angles relative to the axial direction.

8. A system according to claim 1, wherein each movable first wall portion is defined by two parallel lateral edges.

9. A system according to claim 1, wherein the wall structure comprises a plurality of second wall portions, that each first movable wall portion is radially movably arranged between two adjacent second wall portions.

10. A system according to claim 9, wherein the adjacent second wall portions have opposite parallel guide surfaces and that opposite lateral edges of the movable first wall portion is positioned in contact with, or in the close vicinity of, the guide surfaces of the second wall portions in both the first and second position.

11. A system according to claim 1, wherein every second first wall portion in a circumferential direction is fixed with regard to the movable first wall portions.

12. A system according to claim 1, wherein the system comprises a link arrangement adapted to displace the movable first wall portions between the first and second radial positions as the wall structure is advanced and retracted, respectively between the axial positions.

13. A system according to claim 1, wherein the wall structure is configured to allow mixing of the first gas flow with the external second gas flow when the first movable wall portions are in the first radial position.

14. A system according to claim 1, wherein the wall structure is configured to obstruct mixing of the first gas flow with the external second gas flow when the first movable wall portions are in the second radial position.

15. A system according to claim 14, wherein the system comprises an external shroud, that the shroud is provided with at least one opening for inlet of the external gas flow, and that the opening is closed by the wall structure when the wall structure is in the retracted axial position.

16. A system according to claim 1, wherein the system comprises a central cone, and that the wall structure is positioned co-axially with the cone and is axially displacable relative to the cone.

17. A system according to claim 16, wherein the cone has a tapering radial extension from a portion with a maximum radial extension towards an end in the axial direction.

18. A system according to claim 17, wherein a rear end of the wall structure is arranged in the vicinity of the maximum radial extension of the cone in the axially advanced position.

19. A gas turbine engine comprising the mixing system according to claim 1, wherein the mixing system is arranged downstream of a turbine section in the gas turbine engine.

20. A gas turbine engine according to claim 19 wherein the second gas flow is ambient air, which is introduced in the first gas flow via an ejector effect.

21. A gas turbine engine according to claim 19 wherein the first gas flow comprises a core gas flow from the turbine section.

22. An aircraft engine comprising the gas turbine engine according to claim 19, wherein the movable first wall portions are configured to assume the first position during take-off and the second position during cruise.

23. (canceled)
